(19) United States
(12) Patent Application Publication
(10) Pub. No.: US 2007/0083608 A1
(43) Pub. Date: Apr. 12, 2007

(54) Delivering a data stream with instructions for playback

(76) Inventors: Robert A. Baxter, Bedford, MA (US); John D. Puterbaugh, Sterling, MA (US); Epiphany Vera, Lexington, MA (US)

Correspondence Address: FISH & RICHARDSON PC, P.O. BOX 1022, MINNEAPOLIS, MN, 55440-1022, US

(21) Appl. No.: 11/231,302

(22) Filed: Sep. 19, 2005

(51) Int. Cl. G06F 15/16

(52) U.S. Cl. 709/217; 709/231

(57) ABSTRACT

An approach for delivering encoded content data to a portable device is described. The content data is encoded to form encoded content data. The instruction data is combined with the encoded content data to generate a data stream that is able to be recognized by a target operating environment as executable. The data stream is delivered to a portable device capable of running the target operating environment. A program, included in the instruction data, is executed in the target operating environment on the portable device to initiate decoding of the encoded content data based decoding instructions included in the instruction data. The decoded content data is presented on the portable device.

### TECHNICAL FIELD

The invention relates to delivering a data stream with instructions for playback.

### BACKGROUND

The delivery of audio data from a server to a portable device typically includes compression of the audio data before it is transmitted in order to decrease the data size and reduce the download time that results from the limited bandwidth of the communication medium. For example, wireless telephony networks of the type used by mobile phones can have relatively low bandwidth for certain applications. Although the bandwidth of these wireless networks is increasing, the bandwidth of wireless telephony networks can be quite limited, and the likelihood of experiencing a loss of signal can be quite high. Given a limited network bandwidth and frequent signal losses, downloading large files can be extremely cumbersome, if not prohibitive.

In some approaches to delivering audio data to a portable device, the size of downloaded files, or the length of a data stream, is reduced by compressing the audio data using an encoder that represents audio data (or an approximate representation of the audio data) in a more compact form. The data is decompressed using a decoder that resides on the portable device, for example, either as an installed software application or embedded in an integrated circuit on the portable device. As a software application, audio decoders typically use large application files which would take a relatively long time (e.g., minutes) to download over a wireless network with limited bandwidth. Therefore, the portable device is often sold with the decoder software already resident on the device, or software that is separately installed on the device prior to obtaining the content.

An issue related to the delivery of audio data to portable devices is the usage rights associated with the data. Digital Rights Management (DRM) is a term that relates to the restriction of the usage of digital media of any type. Recently, a variety of music download services have become available. The ability to restrict such downloads or to restrict the playback of the downloaded music in some manner related to purchased usage rights is paramount to the continued success of the music download industry.

Another aspect of delivering audio data to a portable device is avoiding the need to store large audio data files on the portable device. One approach is to stream the data to the device. When data are streamed to a device, the data are stored in a temporary buffer which only stores a portion of the data at any given time. Thus, streaming applications do not need to store large amounts of data. Another benefit of streaming is that only a portion of the streamed data remains after the application is terminated so that there is no need to protect downloaded data stored on the device.

### SUMMARY

In a general aspect, the invention features a method, and corresponding server, for delivering encoded content data to a portable device. The content data is encoded to form encoded content data. The instruction data is combined with the encoded content data to generate a data stream that is able to be recognized by a target operating environment as executable. The data stream is delivered to a portable device capable of running the target operating environment. A program, included in the instruction data, is executed in the target operating environment on the portable device to initiate decoding of the encoded content data based decoding instructions included in the instruction data. The decoded content data is presented on the portable device.

Implementations of this aspect of the invention may incorporate one or more of the following:

The method includes selecting an encoding approach used to encode the content data based on at least one characteristic associated with either or both of a source and a destination of the content data.

Selecting an encoding approach includes selecting a codec used to encode the content data.

The characteristic includes a characteristic associated with the portable device.

The characteristic includes a characteristic associated with a network over which the data stream is delivered.

The characteristic includes a characteristic associated with a provider of the content data.

The instruction data includes constraints on usage of the content data.

Presenting the decoded content data on the portable device is subject to the constraints.

The constraints include one or more of: a limit on the number of plays, a limit on the number of minutes of play, a constraint on forwarding, a constraint on downloading, a constraint on streaming, a constraint on purchasing, and an expiration date beyond which the content data cannot be played back on the portable device.

The method includes storing playback information on the portable device.

The method includes comparing the stored playback information with usage constraints derived from the instruction data to determine if the usage constraints are satisfied before playing the audio signal on the portable device.

The method includes encrypting the playback information.

The method includes updating the playback information during presentation of the decoded content data on the portable device.

The program is able to extract the encoded content data from the data stream.

The program is able to extract the encoded content data from the data stream by extracting a playback program from the data stream and initiating the playback program to extract the encoded content data from the data stream.

The content data includes an audio signal.

Presenting the decoded content data on the portable device includes playing a decoded representation of the audio signal on the portable device.

Encoding the audio signal includes adaptive differential pulse code modulation.

Encoding the audio signal includes linear prediction residual coding.

Encoding the audio signal includes encrypting at least a portion of data representing the audio signal.

At least some encoding is performed before the encrypting.

The decoding instructions include a decoder capable of decoding the encoded content data.

The decoder is capable of decoding the encoded content data fast enough to permit playback in real time without interruption.

Delivering the data stream to the portable device includes delivering the data stream to the portable device over a communication network.

The communication network includes a wireless communication network.

The instruction data includes a pointer to a source of additional encoded content data to include in the data stream.

The method includes delivering encoded content data retrieved from the source to the portable device.

The method includes presenting an initial portion of the encoded content data while the additional encoded content data is being retrieved to avoid a delay from being perceived by a user of the portable device during the retrieval.

Advantages may includes one or more of the following:

An encoding approach can be used for delivering content is to a device even when that encoding approach is not supported on the device prior to delivery of the content.

The encoding approach can be tailored to particular capabilities or constraints of the device to which the content is being delivered, or to requirements or limitations that are particular to the user of the device, for example, based on a subscription agreement.

The user does not have to separately install a “player” or other software module prior to playing the content. The required software is delivered to the device along with encoded content.

Startup latency is reduced by sending decoding software along with an initial portion of the encoded content in a first portion of data to the device. A stream for further encoded content can be established while the initial portion plays, thereby avoiding delay perceived by the user.

The operating environment of the device does not have to be configured to receive and play encoded content. For example, as long as the target operating environment is able to receive and execute a program received at the device, required player and decoder instructions can be provided in or retrieved automatically by such a program.

Any of a variety of mobile client devices can receive and play the encoded content without necessarily needing a decoder module to decode the data or an extraction module to detect and extract a bundled decoder. For example, a general purpose operating environment running on a client device can recognize the data stream as executable and enable code provided in the data stream itself to extract any necessary decoding or playback software from the data stream. In some cases, the client device may include a decoder, but it is preferable to use the bundled decoder to provide a desired benefit, such as higher quality playback, for example.

Since data defining usage restrictions can be delivered to the client along with the content and the playback module used to apply the usage restrictions, the usage restrictions can be administered efficiently. For example, the enforcement and content of the usage restrictions can be updated easily without necessarily needing to update an installed base of playback software.

Other features and advantages of the invention will become apparent from the following description, and from the claims.

### DESCRIPTION OF DRAWINGS

FIG. 1 is a diagram of a content delivery system.

FIGS. 2A-2D are diagrams of a bundled data stream.

FIG. 3 is a flowchart of a playback process.

FIG. 4 is a diagram of a wireless communication system.

### DETAILED DESCRIPTION

Overview

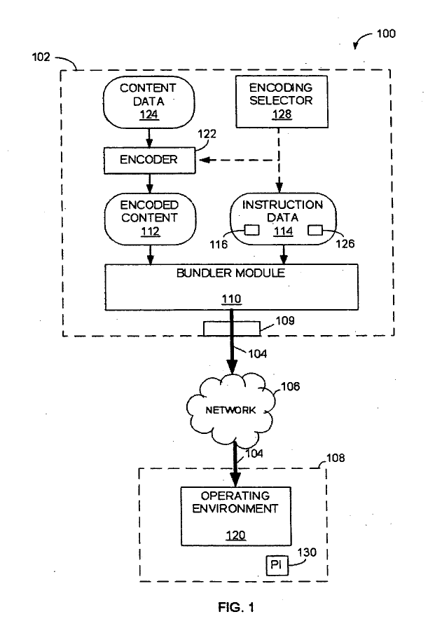

Referring to FIG. 1, a content delivery system 100 includes a server 102 that transmits a data stream 104 to a client device 108 over a network 106. The client device 108 can be a portable device such as a mobile phone, a Personal Digital Assistant (PDA), or a smart phone, for example. A bundler module 110 generates the data stream 104 by combining (or “bundling”) encoded content 112 with instruction data 114 enabling decoding and playback of the encoded content 112.

As described further below, in at least some embodiments, the data stream 104 is formatted or structured such that an operating environment 120 (e.g., Java Virtual Machine (JVM), Binary Runtime Environment for Wireless (BREW), or Symbian OS) running on the client device 108 is able to recognize the data stream 104 as executable. For example, the bundler module 110 is able to format the data stream 104 to conform to a file format appropriate to the operating environment 120. In the case of Java 2 Platform, Micro Edition (J2ME), the appropriate format is a JAR file along with a JAD file. In the case of Symbian OS, the appropriate format is a SIS file.

The operating environment 120 may recognize the data stream 104 as executable in cooperation with an application running in the operating environment 120 and user input. For example, the operating environment 120 (or a browser running in the operating environment 120) may prompt a user to confirm installation of what appears to be an application. In response to the confirmation, the server 102 transmits the data stream 104 to the client device 108 over an interface 109 to the network 106 using communication protocols compatible with the network 106 (e.g., TCP/IP).

The server 102 includes an encoder module 122 that encodes content data 124 (e.g., any one or a combination of text, images, video, and audio) to provide the encoded content 112. The encoder module 122 can use any of a variety of encoding formats. The encoding format is preferably selected to provide low-bit-rate encoding that can be efficiently decoded using a low-complexity decoder with a small program size (footprint). For example, an adaptive differential pulse code modulation (ADPCM) encoding/decoding approach can be used. For cases in which the content data 124 includes a large amount of data to be presented at a predetermined rate (e.g., a digitized audio signal), the encoding approach may compress the content data 124 using lossy compression such that when the encoded content 112 is decoded the resulting decoded content data is an approximate representation of the original content data 124.

The server 102 includes an encoding selector 128, which determines the encoding approach that is most appropriate for the client device 108, the operating environment 120, and/or the user of the device. For example, in making the determination, the encoding selector 128 takes into consideration the type of the operating environment 120, the instruction set of a processor on which the software will be executed in that environment, available software or hardware components of the client device 108, and any user-specific requirements or restrictions.

The instruction data 114 includes a controller program 116 that is able to initiate the process of decoding the encoded content 112 and presenting the decoded content data on the client device 108. The data stream 104 is transmitted to the client device 108, for example as a stream of packetized data, and the instruction data 114 may be extracted progressively in stages. The initial packets may include a relatively compact controller program 116 that is then able to parse the data stream 104 and extract further executable programs, program modules, or resources for executable programs.

For example, the instruction data 114 also includes a decoder module 126 for decoding the encoded content 112. When executed in the operating environment, the controller program 116 extracts the decoder module 126 from the instruction data 114 as the packets are delivered to the client device 108. The decoder module 126 can be an executable decoder program that is capable of decoding the data generated by the encoder module 122. Alternatively, the decoding module 126 can be a “plug-in” module used by an executable program extracted from the instruction data 114 to decode the encoded content 112.

The instruction data 114 can also include other modules for performing various decoding and playback functions. For example, the controller program 116 can extract, and instruct the operating environment 120 to execute, a playback module to present the decoded content data (e.g., playing an audio signal) on the client device 108. The instruction data 114 can include usage constraints (e.g., for DRM) that are used by either or both of the decoder module 126 and the playback module to decode and play back decoded content subject to restrictions specified by the usage constraints. In some implementations, the controller program 116 can be incorporated into a combined controller/playback module that performs both functions described above of the controller program 116 and the playback module.

Encoding Selection Process

The encoding selector 128 selects an encoding approach including the type and/or characteristics of the encoder and associated decoder (or “coder-decoder”, or “codec”) to be used. The encoding selector 128 selects a given codec based on characteristics associated with either or both of a source and a destination of the content data. For example, the encoding selector 128 rates various attributes of multiple possible codecs to select a codec according to constraints imposed by the source or destination of the content. Exemplary attributes include: the output bit rate of the encoder, the decoder complexity, the decoder memory requirements, the decoder program size, and the quality of the decoded content data after encoding and decoding. Exemplary characteristics associated with a source or destination of the content data include: the characteristics of the client device 108, characteristics of the network 106 between the server 102 and the client device 108, and content delivery constraints imposed by the device user's subscription with a content provider.

The following are exemplary constraints for the attributes listed above. The available network bandwidth constrains the allowable bit rates. The device computational power constrains the allowable decoder complexity. The device memory available for applications constrains the decoder memory requirements and program size. The device display and/or playback capabilities as well as the human visual and/or auditory systems constrain the quality of the decoded content data.

Other attributes and corresponding constraints can be considered in the selection process. For example, for applications in which content data is to be encoded with low latency (so called encoding on the fly) the encoder complexity is an additional attribute to be considered in the selection process. For applications in which the user creates content on a portable device and wants to transmit the content to other users, the encoder complexity, memory requirements, and program size are additional attributes to be considered in the selection process.

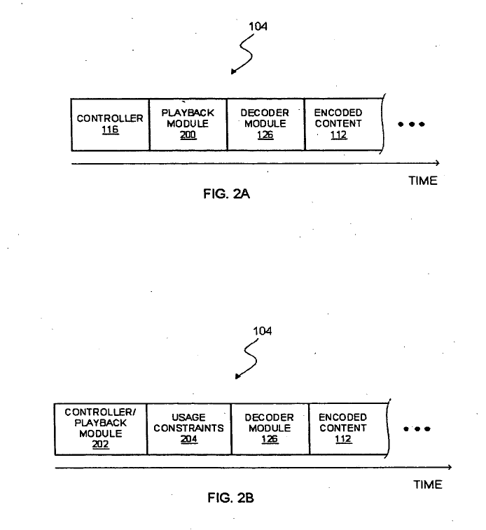

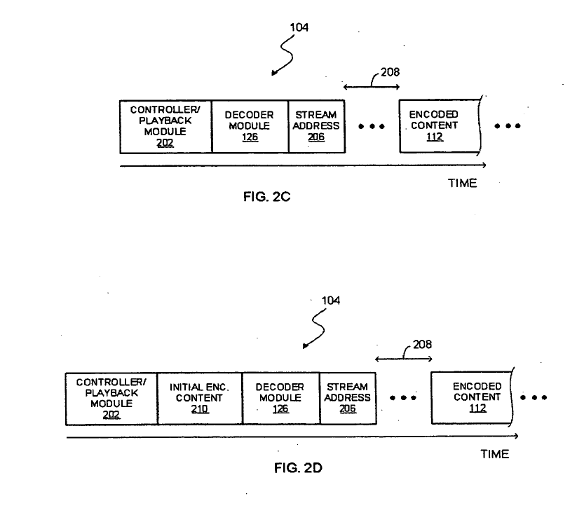

The encoding selection process including the codec attributes used and the constraints on the attributes can be customized based the desired application. In an exemplary selection process, codec selection weights are assigned to each of the codec attributes and the corresponding constraints are specified. A list of available codecs is constructed, each coded having the following attributes: encoder output bit rate, decoder complexity, decoder memory requirement, decoder program size, decoded quality, encoder complexity, encoder memory requirement, and encoder program size. Each codec attribute is rated on an appropriate scale. For example, the encoder output bit rate is rated in units of bits per second, the decoder complexity is rated in terms of the number of seconds it takes to decode a test file on a test machine, the decoder memory requirement is rated in terms of the number of stack and heap bytes required, the decoder program size in rated in terms of bytes, and the decoded quality is rated on a scale inversely proportional to the normalized mean squared error. Many other scales are possible. For example, the decoded quality could be rated on a scale from 0 to 5 with 5 representing no loss in quality. Each attribute rating scale is then modified to range from 0 to 1. For each codec, the modified attribute ratings are multiplied by the corresponding codec selection weights and summed to give a codec selection score. The encoding selector 128 selects the codec with the highest selection score. Bundling the data stream The bundler module 110 may bundle different portions of the encoded content 112 and the instruction data 114 in any of a variety of possible orderings within the data stream 104. FIG. 2A shows one exemplary bundled data stream 104. The controller program 116 at the beginning of the data stream 104 enables the data stream 104 to be recognized by the operating environment 120 as executable. Next in the data stream 104 (in time sequence) is a playback module 200, the decoder module 126, and the encoded content 112.

The controller program 116 may be tailored to the operating environment 120 on a given client device 108. The controller program 116 and the various modules are programmed in a language that can be compiled and built into an executable that an operating environment 120 on the client device 108 supports. In some implementations, the bundler module 110 selects one of multiple available controller programs based on a signal from the client device 108 indicating the operating environment 120 (which may be one of multiple operating environments that the client device 108 is capable of running). In some implementations, one or more of the modules included in the instruction data 114 are “cross-platform” executables capable of running in multiple operating environments 120.

FIG. 2B shows another exemplary bundled data stream 104. In this example, a controller/playback module 202 is at the beginning of the data stream 104, followed by usage constraints data 204, decoder module 126, and encoded content 112. The usage constraints data 204 are input parameters to the controller/playback module 202. In other implementations, usage constraints data 204 can serve as input parameters to the decoder module 126, or the usage constraints data 204 can be embedded in the controller/playback module 202 or the decoder module 126, for example.

The type of constraints specified by the usage constraints data 204 can be based on the type of media being presented. For example, in the case of the content data 124 comprising an audio signal, the usage constraints data 204 can specify constraints on the number of times the audio signal can be played back, the duration of play (i.e., the number of seconds that audio signal can be played back), and an expiration date beyond which the audio signal cannot be played back. Variables keeping track of the playback history can be stored on the client device 108 in an encrypted playback information (PI) file 130. Other types of usage constraints include forwarding constraints, downloading constraints, and streaming constraints.

The usage constraints data 204 can include rights information, such as an encryption key, for implementing a DRM approach. In the case of compressed audio signal, all or only some segments of the compressed audio signal (e.g., every second) can be encrypted such that a full unimpaired version of the compressed audio cannot be stored and uncompressed later without the encryption key. The encryption key can be based on information such as identification information associated with the client device 108 (e.g., for a subscriber, a phone, a session, etc.). The encryption key can change from session to session. Such an approach may be adequate even if a portion of the uncompressed audio is temporarily stored on the client device 108 since there may not be room on a portable client device 108 to store the entire uncompressed audio signal. The encryption type can include, for example, Data Encryption Standard (DES), or Advanced Encryption Standard (AES).

FIG. 2C shows another exemplary bundled data stream 104. In this example, a controller/playback module 202 is at the beginning of the data stream 104, followed by decoder module 126, and a stream address 206. In this example, usage constraints are embedded in the controller/playback module 202. The stream address 206 provides the address of a source of the encoded content 112 from which the client device 108 can request the encoded content 112. The source may be located at the server 102, or alternatively may be hosted by another server accessible over the network 106. In either case, there may be a time delay 208 until the encoded content 112 arrives from the source. This delay 208 can contribute to a delay in playback of the decoded content data.

For example, streaming audio data from the server 102 to the client device 108 can involve considerable delay before the audio begins to play. The streamed audio data is delivered in packets or small segments and stored in a buffer before the contents of the buffer are decoded and played back. The delay before audio begins to play is called startup latency. In this example, there are three primary causes for startup latency: (1) the delay in starting the player and decoder and setting up the buffer for streaming, (2) the delay in establishing a network connection, and (3) the time it takes to download the initial audio data packets into the buffer.

FIG. 2D illustrates an approach to bundling the data stream 104 that reduces latency caused by downloading the initial audio data packets. The controller/playback module 202 includes a pre-caching mechanism that allows initial encoded content 210 (e.g., encoded audio data packets) to be delivered to the client device 108 before the rest of the encoded content 112 is streamed from the source. With proper buffer management, the controller/playback module 202 is able to reduce the startup latency and play back the audio data sooner (e.g., playback can begin during the time delay 208). Also, the server 102 does not necessarily need a large amount of extra storage space to hold initial portions of each of a library of content files (e.g., audio files) available from the source.

Decoder Complexity

The determination of whether and how various factors constrain decoder complexity depends on the way in which the data stream 104 is received by the client device 108. Two potential constraints on decoder complexity are startup latency and network bandwidth. Two exemplary modes of receiving the data stream 104 are: (1) “full download mode” in which all of the encoded content 112 is downloaded to the client device 108 and played back without additional encoded content 112 from the server 102; and (2) “streaming mode” in which initial encoded content 210 is downloaded to the client device 108 before playback begins and the remaining encoded content 112 is streamed to the device in segments or as a continuous data stream after playback has begun. Note that a “data stream” as used herein refers to a sequence of data values and does not necessarily imply that the data stream 104 is played back in any type of streaming mode in which playback begins while the data stream 104 is being received.

A more complex decoder may take a relatively larger amount of time to decode a given amount of data (having a larger “decode time”). The decode time affects the time it takes for the playback to start after receiving the initial encoded content 1 12, and thus affects the startup latency. The lower the decode time, the lower the startup latency.

In full download mode, the ability to decode faster than the rate at which the data stream 104 is delivered to the client device 108 is not necessarily a requirement. So network bandwidth is not necessarily a constraint on decoder complexity in full download mode. However, there may be a constraint on decoder complexity due to the startup latency in full download mode (e.g., in a case in which the startup latency is not negligible compared to the download time).

In streaming mode, to provide uninterrupted playback: (1) the network bandwidth should be high enough to permit playback in real time without interruption; and (2) the decoding of the encoded content 112 should be fast enough to permit playback in real time without interruption. If the network bandwidth is sufficiently high, it is not necessary to decode at a rate faster than the rate at which the encoded content 112 is delivered to the client device 108.

For example, in one scenario the network bandwidth is 8 Mbps and the encoded content 112 is broken up into 10 100 kB segments with each segment representing 20 seconds of audio. In this scenario, it will take 0.1 seconds to download each segment to the device (8 Mbps=1 MBps) but playback of each segment will take 20 seconds. So the decoder could take substantially longer than 0.1 seconds to decode each segment (e.g., less than 19.9 seconds). If the startup latency is required to be less than 5 seconds, then in this scenario the primary constraint on decoder complexity is startup latency.

In another scenario the network bandwidth is 50 kbps (6.25 kBps), and each segment will take 16 seconds to download and the decode time should be substantially faster than the download time (e.g., less than 4 seconds) for uninterrupted playback. If the startup latency is required to be less than 5 seconds, then in this scenario the primary constraint on decoder complexity is network bandwidth.

In general, a combination of factors including network bandwidth and startup latency can be constraints on the decoder complexity.

Playback Process

A user of the client device 108 can submit a request for content from the content delivery system 100 using an interface on the device 108. For example, the user can select a song (or group of songs) to be played using a web browser, a wireless application protocol (WAP) browser, or a premium rate short message service (PSMS). The controller/playback module 202 (or the playback module 200 initiated by the controller program 116) performs a playback process in response to the user request for the content.

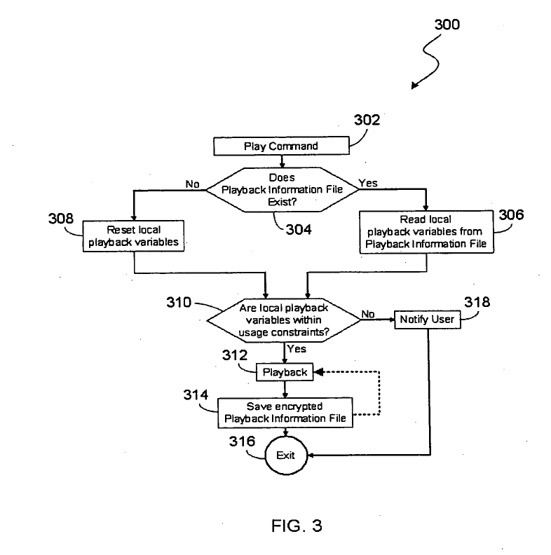

FIG. 3 shows a flowchart representing a playback process 300 performed by the playback module 200 or controller/playback module 202. The playback process 300 starts in response to receiving a play command 302 generated by the user request. The process 300 checks 304 for a PI file 130 on the client device 108. If the PI file 130 exists, the process 300 reads the values of local playback variables from the PI file 130. If the PI file 130 does not exist, the process 300 resets 308 the local playback variables by generating a new PI file 130. The process compares 310 the playback variables in the PI file 130 to usage constraints data 204 to determine whether variables such as the number of plays and the duration of play, are within the usage constraints associated with the data stream 104. If so, the process 300 starts the decoder module 126 and plays back 312 the decoded content data 124.

After the playback ends (or is otherwise terminated) the process 300 saves 314 updated playback variables in the encrypted PI file 130 and exits 316. The process 300 can also be configured to save 314 the updated playback variables in the encrypted PI file 130 one or more times during playback (e.g., periodically saving updated playback variables every second or every 10 seconds).

The algorithm used to encrypt the PI file 130 is preferably characterized by low complexity, small program size, and high resistance to attack. For example, AES can be used. If the playback variables are not within the usage constraints, the process 300 notifies 318 the user and exits 316.

Upon exit 316, the process 300 can be configured to perform various clean-up tasks. For example, process 300 can be configured to delete some or all of the programs extracted from the instruction data 114 on the client device 108. Alternatively, the process 300 can be configured leave the programs loaded on the client device 108 to be used by a future data stream 104.

Any of a variety of different encoding/decoding techniques can be used for a given type of content data 124. For example, some possible characteristics of the encoder module 122 and the decoder module 126 are described below in the context of encoding and decoding audio data.

The encoder module 122 permits a desired output bit rate or output file size to be specified, and is able to handle commonly used sampling rates (e.g., 8, 11.025, 16, 22.05, 32, 44.1, or 48 kHz) and sample resolutions (e.g., 8 or 16 bits). The encoder module 122 is capable of handling single or multichannel (e.g., stereo) audio data. The encoder module 122 is capable of compressing the audio data at low bit rates so that the resulting bit rate of the data stream 104 is less than the supported bit rate of the network 106. In some implementations, the encoder module 122 also performs additional processing of the audio data such as rearranging the audio data for efficient delivery, and performing encryption for DRM.

The decoder module 126 is preferably characterized by low complexity and a small program size. A low complexity decoder is useful in order to decode the audio data without a significant delay. A small program size is useful so that the decoder does not add significantly to the size of the data stream 104 and the resulting download time.

In one embodiment, an ADPCM encoder and decoder provides these characteristics. ADPCM encodes differences between successive amplitude values of a signal using a quantization step size that varies during encoding based on characteristics of the signal. Different types of ADPCM techniques can be used and combined with various techniques including residual coding, multistage waveform vector quantization with residual coding, or the use of a modified discrete cosine transform with multistage vector quantization and adaptive bit allocation.

Network Environment

The network 106 over which the data stream is sent too the device 108 can be any type of network including, for example, wired, wireless, Bluetooth, personal area networks, local area networks, or wide area networks. Some wireless network architectures, such as General Packet Radio Service (GPRS), have bandwidth limitations that can benefit from the techniques described herein. The communications protocol can be used for delivering the data stream 104 to the client device 108 is compatible with the network 106.

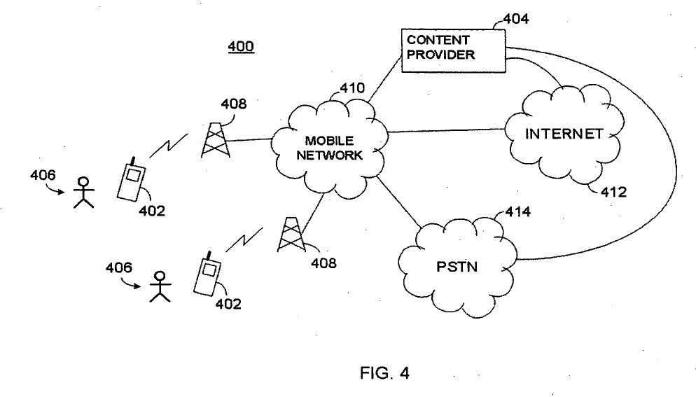

FIG. 4, shows an exemplary wireless communication system 400 in which the content delivery system 100 could be used. The wireless communication system 400 supports transmission of voice and data communication between a number of mobile devices 402 (acting as the client device 108) and a content provider 404 (providing content from a server 102). Mobile devices 402 are operated by mobile users 406 and communicate over wireless links to base transceiver stations (BTS) 408. The BTS 408 are coupled to the content provider 404 over a mobile network 410, which provides a fixed network communication infrastructure for passing communication between the content provider 404 and mobile devices 402. The BTS 408 may also be coupled to the content provider 404 over communication infrastructure that includes other networks such as a data network, here over public Internet 412, or a telephone network, here over Public Switched Telephone Network (PSTN) 414.

Many other implementations other than those described above are within the scope of the following claims. For example, though some examples are described in the context of audio content data, the various aspects of content delivery described herein also apply to other types of content data including video or other types of multimedia content.

What is claimed is:

1. A method for delivering encoded content data to a portable device, the method comprising:
encoding content data to form encoded content data;
combining instruction data with the encoded content data to generate a data stream that is able to be recognized by a target operating environment as executable;
delivering the data stream to a portable device capable of running the target operating environment;
executing a program, included in the instruction data, in the target operating environment on the portable device to initiate decoding of the encoded content data based decoding instructions included in the instruction data;
and
presenting decoded content data on the portable device.

2. The method of claim 1, further comprising selecting an encoding approach used to encode the content data based on at least one characteristic associated with either or both of a source and a destination of the content data.

3. The method of claim 2, wherein selecting an encoding approach comprises selecting a codec used to encode the content data.

4. The method of claim 2, wherein the characteristic comprises a characteristic associated with the portable device.

5. The method of claim 2, wherein the characteristic comprises a characteristic associated with a network over which the data stream is delivered.

6. The method of claim 2, wherein the characteristic comprises a characteristic associated with a provider of the content data.

7. The method of claim 1, wherein the instruction data includes constraints on usage of the content data.

8. The method of claim 7, wherein presenting the decoded content data on the portable device is subject to the constraints.

9. The method of claim 7, wherein the constraints include one or more constraints selected from the group consisting of: a limit on the number of plays, a limit on the number of minutes of play, a constraint on forwarding, a constraint on downloading, a constraint on streaming, a constraint on purchasing, and an expiration date beyond which the content data cannot be played back on the portable device.

10. The method of claim 1, further comprising storing playback information on the portable device.

11. The method of claim 10, further comprising comparing the stored playback information with usage constraints derived from the instruction data to determine if the usage constraints are satisfied before playing the audio signal on the portable device.

12. The method of claim 10, further comprising encrypting the playback information.

13. The method of claim 10, further comprising updating the playback information during presentation of the decoded content data on the portable device.

14. The method of claim 1, wherein the program is able to extract the encoded content data from the data stream.

15. The method of claim 14, wherein the program is able to extract the encoded content data from the data stream by extracting a playback program from the data stream and initiating the playback program to extract the encoded content data from the data stream.

16. The method of claim 1, wherein the content data comprises an audio signal.

17. The method of claim 16, wherein presenting the decoded content data on the portable device comprises playing a decoded representation of the audio signal on the portable device.

18. The method of claim 16, wherein encoding the audio signal includes adaptive differential pulse code modulation.

19. The method of claim 16, wherein encoding the audio signal includes linear prediction residual coding.

20. The method of claim 16, wherein encoding the audio signal includes encrypting at least a portion of data representing the audio signal.

21. The method of claim 20, wherein at least some encoding is performed before the encrypting.

22. The method of claim 1, wherein the decoding instructions comprise a decoder capable of decoding the encoded content data.

23. The method of claim 22, wherein the decoder is capable of decoding the encoded content data fast enough to permit playback in real time without interruption.

24. The method of claim 1, wherein delivering the data stream to the portable device comprises delivering the data stream to the portable device over a communication network.

25. The method of claim 24, wherein the communication network comprises a wireless communication network.

26. The method of claim 1, wherein the instruction data includes a pointer to a source of additional encoded content data to include in the data stream.

27. The method of claim 26, further comprising delivering encoded content data retrieved from the source to the portable device.

28. The method of claim 27, further comprising presenting an initial portion of the encoded content data while the additional encoded content data is being retrieved to avoid a delay from being perceived by a user of the portable device during the retrieval.

29. A server for delivering encoded content data to a portable device, the server comprising:
an encoder module configured to encode content data to form encoded content data;
a bundler module configured to combine instruction data with the encoded content data to generate a data stream that is able to be recognized by a target operating environment as executable; and
a network interface in communication with a network for delivering the data stream to a portable device capable of running the target operating environment;
wherein the instruction data includes a program configured for execution in the target operating environment on the portable device to
initiate decoding of the encoded content data based decoding instructions included in the instruction data, and
present decoded content data on the portable device.

30. The server of claim 29, further comprising an encoding selector coupled to the encoder module and configured to select an encoding approach used to encode the content data based on at least one characteristic associated with either or both of a source and a destination of the content data.

31. The server of claim 29, wherein the instruction data includes constraints on usage of the content data.
